(19) United States
(12) Patent Application Publication
(10) Pub. No.: US 2023/0290430 A1
(43) Pub. Date: Sep. 14, 2023

(54) DEVICE AND A METHOD FOR FLUID MEASURING DEVICE

(71) Applicant: COLLOIDTEK OY, Tampere (FI)

(72) Inventor: Teemu YLI-HALLILA, Tampere (FI)

(73) Assignee: COLLOIDTEK OY, Tampere (FI)

(21) Appl. No.: 18/142,554

(22) Filed: May 2, 2023

Related U.S. Application Data
(63) Continuation of application No. PCT/FI2021/050767, filed on Nov. 11, 2021.

(30) Foreign Application Priority Data
Nov. 11, 2020 (FI) 20206141

(51) Int. Cl. G12B 13/00; G01N 27/10; G01N 27/02; G01N 1/10; G12B 7/00

(52) U.S. Cl. CPC G12B 13/00; G01N 27/10; G01N 27/023; G01N 1/10; G12B 7/00; G01N 2001/1006

(57) ABSTRACT

A method and a device for calibrating a measuring device configured to measure a liquid (MX) comprising colloidal particles. A calibrating function is selected among a plurality of fitting functions. A group of fitting functions are constructed by utilizing different combinations of measurement data. The calibration function is the one with the smallest maximum error.

### BACKGROUND

A fluid or a liquid may be measured by providing an oscillating electric field to the liquid and using at least one capacitive electrode to detect response to the electric field. The input impedance comprises a real portion and an imaginary portion, which may be used to measure the liquid properties, such as permittivity and ion viscosity. The measurement may be applied to various liquids, wherein several factors, such as liquid's temperature, may cause error to the measurement.

Traditionally measurement devices for liquids have been calibrated using calibration liquids that have known parameters. For example, the response on different temperatures is known and the measurement device may be calibrated to match the expected result, for example by a temperature compensation parameter. However, the calibration liquid may be difficult to apply to ongoing industrial processes. The measurement may be affected by various other parameters than temperature; position, orientation or travel of particles in a colloidal liquid. The sensor may be immersed in the liquid or the measurement may be conducted through a container. The liquid's temperature may have a combined effect with any another parameter in the industrial process environment. The measured liquid may have different thermal behaviour than the calibration liquid.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for calibrating a measuring device, and a device for performing the method are disclosed herein. The measuring device provides an oscillating electromagnetic field to a fluid and measures complex impedance of the fluid in response to the electromagnetic field. The determinations of fluid characteristics are performed by analysis of complex impedance and resonant frequency of the oscillating electromagnetic field. In one exemplary embodiment the electromagnetic field oscillates at a radio frequency. In the disclosure herein, fluid refers to liquid or gas, according to the context of the disclosure.

The method comprises receiving at least four series of data. A first series of measurement data comprises permittivity of a fluid. Permittivity may be obtained from a real part of the complex impedance. A second series of measurement data comprises ion viscosity of the fluid. Ion viscosity may be obtained from an imaginary part of the complex impedance. A third series of measurement data comprises temperature of the fluid. The fluid temperature may be obtained from a thermometer that may be integrated into the measuring device or the thermometer may be separate component. A fourth series of data is a reference quantity of the fluid, wherein the reference quantity is other than permittivity or ion viscosity measured by the measuring device. The fourth series of data may be constructed from the first, second or third series of measurement data, or from any combination of the first, second or third series of measurement data.

In one exemplary embodiment data points in each series are synchronized. The measurements may be performed simultaneously or within a predetermined time frame. The predetermined time frame ensures that the temperature does not fluctuate in relation to the measurement data.

A first correlation is calculated between the first series and the fourth series; between the permittivity and the reference quantity. In one exemplary embodiment the calculation results a first correlation coefficient between the first series and the fourth series. A second correlation is calculated between the second series and the fourth series; between the ion viscosity and the reference quantity. In one exemplary embodiment the calculation results a second correlation coefficient between the second series and the fourth series. Out of the first series and the second series is selected the one with higher correlation with the fourth series, the reference quantity.

A mathematical model is fitted between the selected series and the fourth series. In one exemplary embodiment the mathematical model is a linear function. The mathematical model may be a polynomial function, exponential function, logarithmic function, Gaussian model, static model or dynamic model. In many examples the linear fitting may be considered adequate as the applied temperature range may be within few degrees in a Celsius scale.

At least one temperature compensation parameter is selected based on said mathematical model and the third series, the temperature or acidity of the fluid. In one exemplary embodiment the compensation parameter is a temperature coefficient. Said method is suitable for short range measurements.

The measurement by detecting the loss of in the electromagnetic field caused by the fluid is susceptible to multiple variables. Any change in the fluid's substance may be detected. As one example, if the acidity of the liquid, a pH value, is known to fluctuate during the process, the remaining of the first and second series may be used to compensate the fluctuations of the pH value. The acidity may be measured separately and compensated in similar manner as the temperature.

In one exemplary embodiment, chemometrics is applied as multivariate calibration. A model is developed to predict properties based on temperature of the liquid, wherein the applicable parameters are permittivity and ion viscosity of the liquid. The calibration process may be continuous along the measuring the industrial process. The third series, temperature, comprises initial reference values that provide initial calibration parameters. Multivariate calibration techniques comprise on one embodiment partial-least squares regression or principal component regression for providing the mathematical model.

For a longer measurement range, the compensation parameter for calibrating the measuring device is constructed into a function that is configured to compensate the measurement data, or series of measurement data. In one use scenario the measurements are conducted as a frequency sweep, resulting to series of measurement data. The process starts by creating a group of curve fitting functions, utilizing different combinations of the temperature measurement series with the first series of measurement data, the second series of measurement data and/or series of constructed data. Out of the multiple curve fitting functions, the best fit to the measured data is selected. The curve fitting function is used for calibrating the measurement results and providing that the measuring device provides improved measurement data. The temperature variation has been detected as a dominant factor in most measurements, and it has been chosen to be the used in every combination of data fitting functions.

The calibration described herein is fast and economical. It may be applied during the industrial process as the measuring device may be calibrated continuously, using the measurements from the pre-existing process parameters. The measurement data may later compensated or adjusted. The data may be collected and stored on-site, and later transferred for further analysis. The measurement data may be managed via cloud computing environment. The measurement data for any of said data series may be transmitted via Internet of Things IoT. The measurement data for any of said data series may be monitored via a user interface residing on a cloud computing environment.

Many of the attendant features will be more readily appreciated as they become better understood by reference to the following detailed description considered in connection with the accompanying drawings. The embodiments described below are not limited to implementations which solve any or all the disadvantages of calibrating a measuring device.

### BRIEF DESCRIPTION OF THE DRAWINGS

The present description will be better understood from the following detailed description read in light of the accompanying drawings, wherein

FIG. 1 illustrates schematically one exemplary embodiment of a measuring device arranged to measure at least one property of a fluid;

FIG. 2 illustrates one example of the waveforms of the current and voltage of a driving signal;

FIG. 3a illustrates schematically one exemplary embodiment of a simplified model of a measurement head;

FIG. 3b illustrates schematically one exemplary embodiment of a simplified model of the measurement head connected to the measuring device;

FIG. 4a illustrates one exemplary chart showing a gain response curve associated with a first composition of the fluid;

FIG. 4b illustrates one exemplary chart showing a gain response curve associated with a second composition of the fluid;

FIG. 5a illustrates one exemplary embodiment of a structure of electrically conductive parts of a sensor unit;

FIG. 5b illustrates one exemplary embodiment of the sensor unit in a container containing fluid;

FIG. 5c illustrates one exemplary embodiment of the sensor unit in the container containing fluid;

FIG. 5d illustrates a cross-sectional view of one exemplary embodiment of the sensor module;

FIG. 6 illustrates one example of the phase difference between current and voltage waveforms of a reader coil;

FIG. 7 illustrates a flowchart of one aspect of the method for calibrating the measuring device;

FIG. 8a illustrates a chart of exemplary measurement data;

FIG. 8b illustrates a table of data points with same measurement data of FIG. 8a;

FIG. 9a illustrates a chart of fourth series of measurement data;

FIG. 9b illustrates a table comprising values of FIG. 9a;

FIG. 10a illustrates one simplified example of an evenly dispersed colloid;

FIG. 10b illustrates one simplified example of an agglomerated suspension;

FIG. 11 illustrates a flowchart of one aspect of the method for calibrating the measuring device;

FIG. 12 illustrates a table applying a sequence for group of fittings with alternative combinations of series of measurement data; and

FIG. 13 illustrates one example of a polynomial regression plot with single outlier result.

Like reference numerals are used to designate like parts in the accompanying drawings.

### DETAILED DESCRIPTION

The detailed description provided below in connection with the accompanying drawings is intended as a description of the present examples and is not intended to represent the only forms in which the present example may be constructed or utilized. However, the same or equivalent functions and sequences may be accomplished by different examples.

Although the present examples are described and illustrated herein as being implemented in measuring device calibration, these are provided as an example and not a limitation. As those skilled in the art will appreciate, the present examples are suitable for application in a variety of different devices requiring calibration.

In the present disclosure the calibration is referred as determining, rectifying, adjusting precisely for a particular function or standardizing by determining the deviation from a standard so as to ascertain the proper correction factors. The calibration may be regarded as scaling or compensation focusing on a measuring device. In this disclosure, fluid refers to liquid or gas, according to the context of the disclosure.

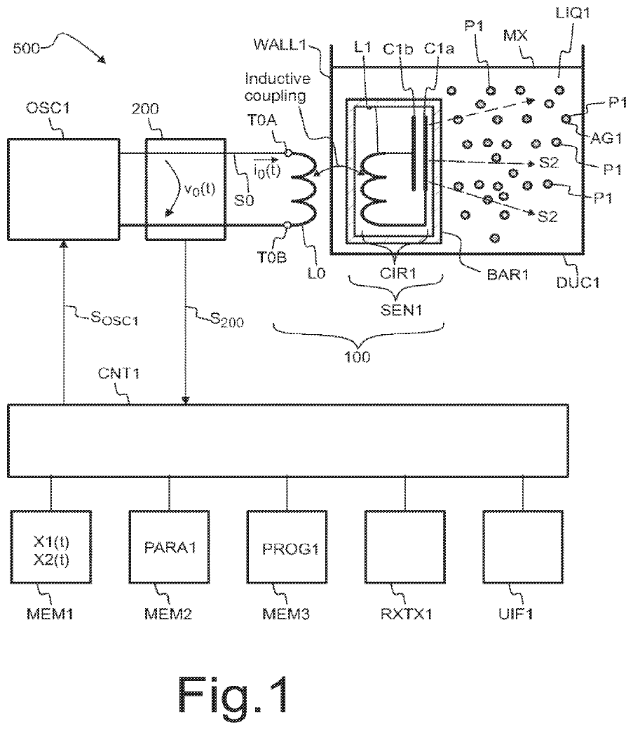

FIG. 1 illustrates schematically one exemplary embodiment of the measuring device 500 arranged to measure at least one property of a fluid MX. The fluid MX may be a liquid, a mixture, a heterogenous mixture, a homogenous mixture, a colloid, a solution, a suspension, a gel or a foam. The measuring device 500 comprises a sensor 100, a signal generator OSC1, an impedance monitoring unit 200, at least one processor CNT and a memory MEM. The memory MEM stores instructions that are executable by the processor CNT to cause the measuring device 500 to perform the steps described herein.

The fluid MX may be confined in a container or duct DUC1. In one example the duct DUC1 is one element of an industrial process configured to transfer the fluid MX. The sensor 100 comprises a sensor module SEN1 and a reader coil L0. The reader coil L0 is configured to couple operating energy to the sensor module SEN1 and to read information from the sensor module SEN1. In one embodiment the sensor module SEN1 comprises at least one capacitive electrode C1a. The capacitive electrode C1a is arranged to couple an oscillating electromagnetic field S2 to the fluid MX.

The dielectric permittivity of the fluid MX has an effect on the input impedance ZSEN of the sensor module SEN1. Consequently, at least one property X1 of the fluid MX may be determined by monitoring the input impedance ZSEN of the sensor module SEN1. The impedance ZSEN may, in turn, be monitored by monitoring the impedance of the reader coil L0 when the reader coil L0 is inductively coupled to the sensor module SEN1.

Using the measuring device comprises coupling an oscillating radio frequency electromagnetic field S2 to the fluid MX by using at least one capacitive electrode C1a. At least one property X1 of the fluid MX is determined by monitoring the input impedance ZSEN of the sensor module SEN1, utilizing the capacitive electrode C1a. The sensor module SEN1 comprises a resonator circuit CIR1. The electromagnetic field S2 emitted from the capacitive electrode C1a interacts with the fluid MX such that the complex permittivity of the fluid MX has an effect on the resonating frequency and/or on the Q-factor of the resonator circuit CIR1.

The capacitive electrode C1a may be a capacitive element, which may form a capacitor C1 together with a second capacitive element C1b. The second capacitive element C1b may also operate as an capacitive electrode. The resonator circuit CIR1 may be an inductor-capacitor (LC) resonance circuit. The capacitive electrode C1a may operate as a capacitive component of the resonance circuit CIR1. The capacitive electrode C1a may be arranged to operate as a part of the resonance circuit CIR1 such that a resonance frequency fp of the resonance circuit CIR1 depends on the impedance of the capacitor C1, which comprises the capacitive electrode C1a. The sensor module SEN1 may comprise a resonance circuit CIR1, the resonance circuit CIR1 may be an inductor capacitor resonance circuit, the capacitive electrode C1a may be a capacitive element, and the capacitive electrode C1a may operate as a capacitive component of the resonance circuit CIR1.

The resonator circuit CIR1 comprises a first inductor L1. The first inductor L1 operates as an inductive component of the resonance circuit CIR1. The first inductor L1 may be connected in parallel with the capacitor C1 and/or in series with the capacitor C1.

In one embodiment the sensor unit 100 comprises a second inductor L0. The second inductor may also be called as a reader coil. In one embodiment the first inductor L1 is inductively coupled to the second inductor L0. The inductor L0 form an inductive link together with the inductor L1. The second inductor L0 may inductively transfer operating energy to the resonator circuit CIR1. The resonator circuit CIR1 oscillates by applying a driving signal S0 to the second inductor L0. The method may comprise applying the driving signal S0 to the second inductor L0 so as to cause oscillation of the resonance circuit CIR1.

The measuring device monitors an input impedance Z100 of the sensor unit 100 which comprises the second inductor L0 and the resonance circuit CIR1. The input impedance Z100 of the sensor device 100 is obtained from the complex ratio of the voltage v0(t) to the current i0(t) in a situation where the resonator circuit CIR1 is inductively coupled to the reader coil L0.

The second inductor L0 is in one embodiment galvanically separated from the first inductor L0 in order to reduce signal noise. The inductor L0 may inductively couple operating power to the inductor L1 of the resonance circuit CIR1. This arrangement allows simple and rugged construction, a short range wireless measurement. The arrangement also allows measurement through materials, such as pressurized dielectric wall of the duct or container DUC1. The material of the duct or container DUC1 may be plastic, glass or reinforced composite. The duct or container DUC 1 may be a bottle, such as a wine bottle.

In one exemplary embodiment the inductor L0 is a reader coil, and the inductor L1 is a sensor coil. The distance between the reader coil L0 and the inductor coil L1 is in the range of 0.01 to 3 times the diameter of the sensor coil L1. The distance between the reader coil L0 and the inductor coil L1 is in the range of 0.1 to 2 times the diameter of the sensor coil L1. Other arrangements or dimensions may be applied to reach the same effect.

In one exemplary embodiment the inductor L0 is galvanically connected to the first inductor L1. A part of the inductor L1 may operate as the second inductor L0. The driving signal S0 is coupled to the resonance circuit CIR1 also without using the inductor L0. For example, the driving signal S0 may be coupled to the resonance circuit CIR1 via a capacitor or via a resistor. The driving signal S0 may be directly coupled to the resonance circuit CIR1.

In one exemplary embodiment the signal generator OSC1 generates a driving signal S0, which may be coupled to the sensor module SEN1 by using the reader coil L0. The driving signal S0 has an instantaneous voltage v0(t) and an instantaneous current i0(t). The frequency of the driving signal S0 is in one embodiment in the range of 100 kHz to 1 GHz, and in one embodiment in the range of 10 MHz to 100 MHz. The frequency of the electromagnetic field S2 is in one embodiment in the range of 100 kHz to 1 GHz, and in one embodiment in the range of 10 MHz to 100 MHz.

The complex dielectric permittivity of the fluid MX has a real part and an imaginary part. The sensor unit 100 may transfer energy from the signal generator OSC1 to the fluid MX, depending on the imaginary part of the dielectric permittivity of the fluid MX. The combination of the sensor unit 100 and the fluid MX may absorb energy from the signal generator OSC1. The combination may absorb more energy when the frequency of the driving signal S0 is equal to the resonance frequency fp of the resonance circuit CIR1, and the combination may absorb less energy when the frequency of the driving signal S0 is equal to the resonance frequency fp of the resonance circuit CIR1. The transfer of energy from the reader coil L0 to the resonance circuit CIR1 may be more efficient when the frequency of the driving signal S0 is equal to the resonance frequency fp of the resonance circuit CIR1, and the transfer of energy may be less efficient when the frequency of the driving signal S0 is different from the resonance frequency fp of the resonance circuit CIR1. The sensor unit 100 may also be understood to reflect energy back to the signal generator OSC1 so that the reflection coefficient has a minimum at the resonance frequency fp.

In one embodiment the measuring device 500 comprises an impedance monitoring unit 200, arranged to monitor the impedance of the resonance circuit CIR1. In one embodiment the measuring device 500 monitors the impedance of a system comprising the second inductor L0, the resonator circuit CIR1, the capacitive electrode C1a, and the fluid MX.

The impedance monitoring unit 200 monitors the impedance by monitoring the current i0(t) and/or voltage v0(t) of the driving signal S0. Alternatively, or in addition, the impedance monitoring unit 200 monitors the impedance by comparing the magnitude of the current i0(t) with the magnitude of the voltage v0(t). The impedance monitoring unit 200 may monitor the impedance by monitoring the phase difference ΔT between the current i0(t) and voltage v0(t). The impedance monitoring unit 200 may monitor the impedance by comparing the magnitude and phase of the current i0(t) with the magnitude and phase of the voltage v0(t). The impedance monitoring unit 200 may monitor the impedance by detecting a change of the current i0(t) and/or voltage v0(t).

In one embodiment the sensor unit 100 comprises a dielectric layer BAR1 to electrically insulate the capacitive electrode C1a from the fluid MX. The dielectric layer BAR1 may also be called as a barrier layer. The dielectric layer BAR1 may provide a minimum distance between the capacitive electrode C1a and the fluid MX. Various factors may produce errors to the measurement. The fluid MX itself may disturb or prevent operation of the resonance circuit CIR1, if the distance between the capacitive electrode C1a and the fluid MX is too small. The minimum distance between the capacitive electrode C1a and the fluid MX may be in the range of 0.1 to 5 mm.

The dielectric layer BAR1 may cover or surround at least the capacitive elements C1a, C1b of the resonance circuit CIR1. The dielectric layer BAR1 may cover or surround the electrically conductive components of the resonance circuit CIR1. The dielectric layer BAR1 may comprise or consist of plastic, resin, glass, or ceramic material. Absorption of a material from the fluid MX into the dielectric layer BAR1 may cause an error in the measurement result. The material of the dielectric layer BAR1 may be selected so as to reduce absorption of the liquid medium LIQ1 of the fluid MX into the dielectric layer BAR1. The porosity of the dielectric layer BAR1 may be lower than 1%, lower than 0.1% or even lower than 0.01%. Water absorption of the layer BAR1 may be lower than 1%, lower than 0.1% or even lower than 0.01% by weight during a time period of 1000 hours at the temperature of 25° C. and at the constant absolute pressure of 100 kPa.

The sensor module SEN1 may comprise the resonance circuit CIR1, the capacitive electrode C1a, and the dielectric layer BAR1. The sensor unit 100 may comprise the sensor module SEN1 and optionally also the reader coil L0. The sensor unit 100 may also be called as a measuring device 100 or as a measuring head. The sensor module SEN1 or the sensor unit 100 may be immersed in the fluid MX.

The sensor module SEN1 has in one embodiment a planar form such that the sensor module SEN1 may be attached to the inner or outer surface of a duct or container. The sensor module SEN1 may be attached to a surface by an adhesive, by mechanical fixing means, or by gravity. Positioning the sensor module SEN1 outside the duct or container may provide a rugged and stable set-up. Positioning the sensor module SEN1 outside the duct or container may be used when the fluid MX is corrosive and/or abrasive, and could cause damage to the sensor module SEN1.

A duct or container DUC1 has a wall WALL1. The wall WALL1 may comprise electrically insulating material such that energy may be inductively coupled through the wall WALL1. In one embodiment the sensor unit 100 is implemented in a distributed manner such that the reader coil L0 is positioned on an outer side of the wall WALL1, and the resonance circuit CIR1 is positioned on an inner side of the wall WALL1. Thus, it is not necessary to provide an opening in the wall WALL1 in order to immerse capacitive electrode C1a in the fluid MX. This set-up allows measurements in a pressurized duct or container DUC1. Positioning the sensor module SEN1 inside the duct or container allows detecting small changes in the at least one property X1, X2.

The resonance circuit CIR1 may be a passive circuit. The resonance circuit CIR1 may be implemented such that it does not comprise a power source galvanically connected to the resonance circuit CIR1. The operating power may be inductively coupled to the resonance circuit CIR1 via the coils L0, L1.

The measuring device 500 comprises in one embodiment a signal generator OSC1. The signal generator OSC1 provides an oscillating driving signal S0 to the reader coil L0 or to the resonance circuit CIR1. The variable frequency f of a driving signal S0 is coupled to the resonance circuit CIR1. The signal generator OSC1 may be arranged to vary the frequency of the driving signal S0, for example in one embodiment the signal generator OSC1 sweeps the frequency of the driving signal S0. The frequency of the driving signal S0 is in the range of 100 kHz to 1 GHz, or in the range of 10 MHz to 100 MHz. As one example, the frequency of the signal S0 sweeps in a range between fMIN and fMAX, wherein the maximum frequency fMAX is 150% of the minimum frequency fMIN. The number of sweeps per second may be higher than 1/s, higher than 10/s, higher than 100/s, or even higher than 1000 sweeps/second. In an embodiment, the driving signal S0 is a pseudorandom binary sequence. Alternatively, or in addition, the data processor CNT1 controls the operation and/or frequency of the signal generator OSC1 by sending a control signal SOSC1 to the signal generator OSC1.

The measuring device 500 comprises in one embodiment an impedance monitoring unit 200. The impedance monitoring unit 200 provides a monitoring signal S200 indicative of the impedance of the resonance circuit CIR1. The impedance monitoring unit 200 provides a monitoring signal S200 indicative of the impedance of the measurement head 100. The impedance monitoring unit 200 is in one embodiment arranged to provide a monitoring signal S200 by monitoring the current i0(t) and voltage v0(t) of the driving signal S0 coupled to the resonance circuit CIR1. The monitoring signal S200 may be close to the voltage over the reader coil L0 when an oscillator voltage VOSC(t) is coupled to the reader coil L0 through an auxiliary impedance, for example a resistor. The monitoring signal S200 may also be proportional to the electric current through the reader coil L0. The monitoring signal S200 may also be proportional to the voltage difference over the auxiliary impedance Z200.

The measuring device 500 may comprise a data processor CNT1 for controlling operation of the measuring device 500 and/or for processing data. The measuring device 500 may optionally comprise a memory MEM1 for storing measured data and/or for storing values X1, X2 determined from the measured data. The measuring device 500 may optionally comprise a memory MEM2 for storing auxiliary parameters PARA1. The auxiliary parameters PARA1 may comprise calibration parameters and/or operating parameters for controlling the frequency of the signal generator OSC1. The measuring device 500 may optionally comprise a memory MEM3 for storing computer program code PROG1. The computer program code PROG1 may cause, when executed by the data processor CNT1, determining one or more parameters of the fluid MX by monitoring the impedance of a resonance circuit CIR1. The measuring device 500 may optionally comprise a user interface UIF1 for displaying measured data and/or for receiving user input from a user. The user interface UIF1 may comprise a touch screen, a display and/or one or more keys.

In one embodiment the measuring device 500 comprises a transceiver RXTX1. The transceiver RXTX1 may be arranged to transmit data and/or receive data. The transceiver RXTX1 may be arranged to communicate with a computer or with data server. The transceiver RXTX1 may be arranged to communicate with a control unit of an industrial process. The transceiver RXTX1 may be arranged to communicate via the Internet, via a mobile communications network, via a wireless local area network, via an electric cable, and/or via an optical cable. The transceiver RXTX1 may be arranged to communicate according to the Bluetooth standard.

In one exemplary embodiment the measuring device 500 is arranged to process data in a distributed manner. The data processor CNT1 may be remote from the sensor module SEN1. Measured data S200 may be transmitted, by the transceiver RXTX1 to the data processor CNT1, and one or more property values X1, X2 may be determined from the data S200 at the location of the remote computer CNT1. Measured data S200 may be transmitted to the remote data processing unit CNT1 via the Internet.

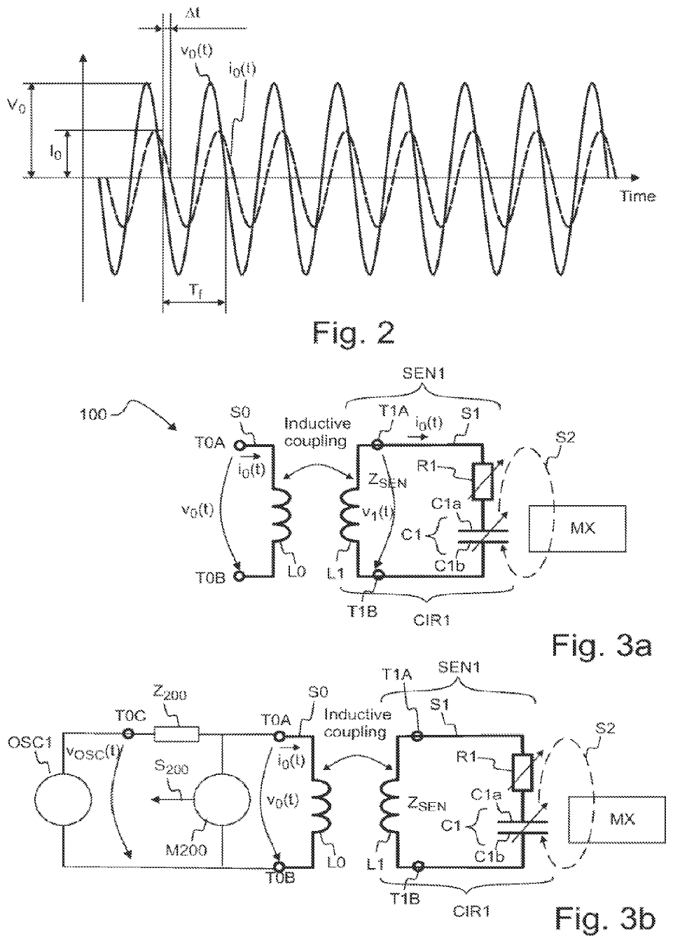

FIG. 2 illustrates one example of the waveforms of the current i0(t) and voltage v0(t) of the driving signal S0. The voltage amplitude is V0 and current amplitude is I0. Tf denotes the period of the voltage v0(t). The frequency f of the voltage v0(t) is equal to 1/Tf. At denotes the time delay between the zero crossing points of the voltage v0(t) and current i0(t). The phase difference Δφ between the voltage v0(t) and the current i0(t) is proportional to Δt/Tf.

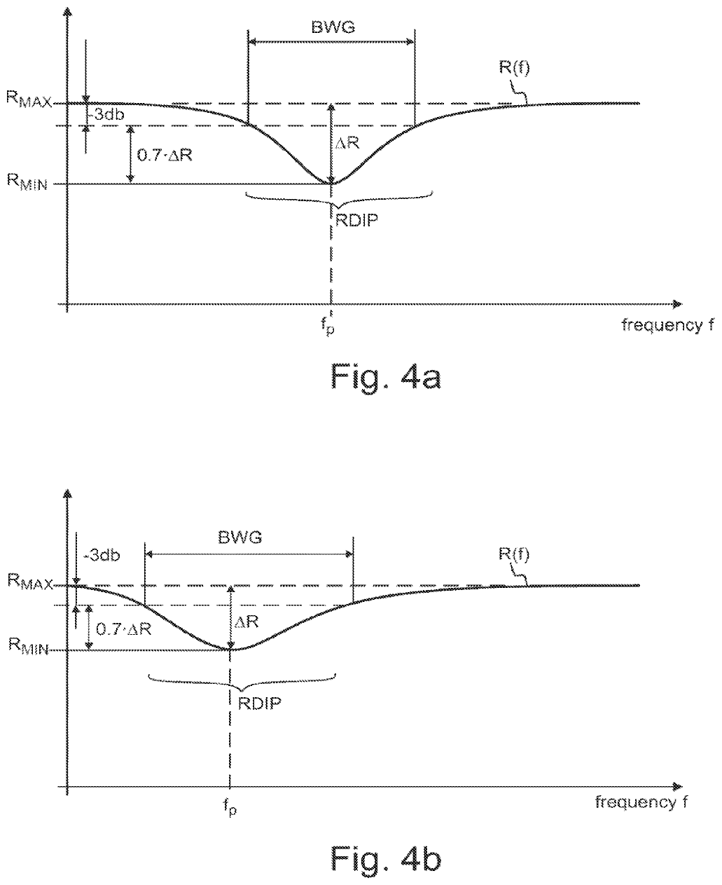

FIG. 3a shows as one exemplary embodiment a simplified model of the measurement head 100. The resonance circuit CIR1 is an inductor-capacitor circuit, LC circuit, comprising a capacitor C1 and the first inductor L1. The capacitor C1 may be connected in series or in parallel with the inductor L1. The capacitor C1 may comprise two or more capacitive elements, such as capacitive electrode C1a and a second capacitive element C1b. The capacitive electrode C1a couples an oscillating electromagnetic field S2 to the fluid MX. The complex permittivity of the fluid MX has an effect on the capacitance value of the capacitor C1 and/or on an effective resistance R1 of the resonance circuit CIR1. A change of the real part of the permittivity of the fluid MX changes the capacitance value of the capacitor C1. A change of the imaginary part of the permittivity of the fluid MX changes the resistance R1 of the resonance circuit CIR1.

In one embodiment he oscillating driving signal S0 is coupled to input nodes T0A, T0B of the reader coil L0. The driving signal S0 is inductively coupled from the reader coil L0 to the sensor coil L1. The driving signal S0 induces an oscillating sensor signal S1 in the resonance circuit CIR1. The sensor signal S1 comprise an oscillating current and voltage. The frequency of the sensor signal S1 and the frequency of the electromagnetic field S2 are equal to the frequency of the driving signal S0.

The sensor module SEN1 may be sensitive to changes, which take place in a sample volume of the fluid MX in the vicinity of the one or more capacitive electrodes C1a, C1b. The dimensions of the sample volume may depend on the width of the capacitive electrode C1a and on the distance between the electrodes C1a, C1b. The width of the capacitive electrode C1a may be in the range of 1 mm to 100 mm. The width of the capacitive electrode C1a may be in the range of 5 mm to 20 mm. The distance between the electrodes C1a, C1b. may be in the range of 10 μm to 10000 μm. The distance between the electrodes C1a, C1b. may be in the range of 50 μm to 500 μm. The distance between the electrodes C1a, C1b. may be in the range of 1 mm to 10 mm in order to provide a long detection range. The surface area of one side the element C1a may be in the range of 1 mm2 to 105 mm2. The surface area of one side the element C1a may be in the range of 10 mm2 to 103 mm2. The shape of the element C1a may be rectangular, elliptical or circular.

The reader coil L0, the resonance circuit CIR1, and the sample volume of the fluid MX form a combination that provide the measurable effect. The term coupled reader coil L0 refers to the reader coil L0 which is coupled to the resonance circuit CIR1 via the sensor coil L1. The impedance of the coupled reader coil depends at least on the input impedance ZSEN of the sensor module SEN1. The term decoupled reader coil L0 refers to the reader coil L0 which is not coupled to the resonance circuit CIR1. The complex impedance of the coupled reader coil L0 depends at least on the complex impedance of the sample volume of the fluid MX. The complex impedance of the decoupled reader coil L0 does not depend on the complex impedance of the sample volume of the fluid MX. The complex impedance of the coupled reader coil L0 is determined from the instantaneous current i0(t) and/or voltage v0(t) of the coupled reader coil L0. The method may comprise using the reader coil L1 to measure the behaviour of the resonance circuit CIR1. The impedance of the fluid MX may be monitored by monitoring the response of the resonance circuit CIR1 to the driving signal S0 coupled to the reader coil L1. The use of the resonance circuit CIR1 may facilitate monitoring of the complex dielectric permittivity of the sample volume. The use of the resonance circuit CIR1 may facilitate detecting a change of the complex dielectric permittivity of the sample volume. The use of the resonance circuit CIR1 may improve signal to noise ratio of the measurement. The measurement measuring device 500 may be arranged to monitor the sample volume by monitoring the impedance of the coupled reader coil L0.

T1A denotes a first node of the inductor L1, i.e. the sensor coil L1. T1B denotes the second node of the inductor L1. The sensor coil L1 is connected between the nodes T1A, T1B; i1(t) denotes the instantaneous current of the sensor coil L1; v1(t) denotes the instantaneous voltage of the sensor coil L1. The input impedance ZSEN of the sensor module SEN1 refers to the complex ratio of the voltage vi(t) to the current i1(t).

The term coupled sensor coil L1 refers to the sensor coil L1 which is operating as a part of the resonance circuit CIR1 and which is also inductively coupled to the reader coil L0. The measuring device 500 is arranged to monitor the sample volume by monitoring the impedance of the sensor coil L1. The measuring device 500 is arranged to monitor the sample volume by monitoring a change of the impedance of the sensor coil L1. The measuring device 500 is arranged to monitor the impedance of the coupled sensor coil L1 by monitoring the impedance of the coupled reader coil L0.

Referring to FIG. 3b, the oscillator signal vOSC(t) obtained from the signal generator OSC1 is coupled to the reader coil L0 via a reference impedance Z200. The reference impedance Z200 may be implemented by using a resistor, a capacitor and/or an inductor. In one embodiment, the oscillator signal vOSC(t) is coupled to the reader coil L0 through a resistor. The ratio of the voltage v0(t) of the driving signal S0 to the primary oscillator signal vOSC(t) may be called as the gain response R(f). The voltage v0(t) has a phase difference with respect to the oscillator signal vOSC(t). Vo denotes the amplitude of the oscillating voltage v0(t), and VOSC denotes the amplitude of the oscillating voltage vOSC. The real part of the gain response R(f) is proportional at least to the ratio V0/VOSC. The magnitude of the gain response R(f) is proportional at least to the ratio V0/VOSC. The gain response R(f) may exhibit a dip in the vicinity of the resonance frequency fp of the circuit CIR1. The gain response may depend on the frequency f of the oscillator signal vOSC(t). The oscillating frequency of the circuit CIR1 may be equal to the frequency f of the oscillator signal vOSC(t). The inverse 1/R(f) of the gain response R(f) may exhibit a peak in the vicinity of the resonance frequency fp of the circuit CIR1.

The input impedance ZSEN of the resonance circuit CIR1 refers to the impedance of the coupled sensor coil L1. The impedance of the coupled reader coil L0 may be monitored by using a monitoring unit 200, which comprises a reference impedance Z200 and a voltage meter M1. The impedance of the coupled sensor coil L1 may be monitored by using a monitoring unit 200, which comprises a reference impedance Z200 and a voltage meter M1. The impedance of the resonance circuit CIR1 may be monitored by using a monitoring unit 200, which comprises a reference impedance Z200 and a voltage meter M1. In one embodiment, the reference impedance Z200 is implemented by using resistor.

The signal generator OSC1 provides an oscillating voltage signal vOSC(t), which has a substantially constant amplitude. The voltage meter M1 monitors the voltage v0(t). The voltage signal vOSC(t) may be coupled to the inductor L0 via a resistor Z200 so that the voltage difference over the resistor Z200 is proportional at least to the current i0(t). Consequently, an increase of the current i0(t) may cause a reduction of the voltage v0(t). The frequency f of the voltage signal vOSC(t) may be varied, and a gain response curve R(f) may be determined by measuring the amplitude of the voltage v0(t) as the function of the frequency f, and by comparing voltage v0(t) of the inductor L0 with the voltage vOSC(t). The voltage vOSC(t) may refer to the voltage between nodes T0C and T0B. The voltage v0(t) may refer to the voltage between nodes T0A and T0C. The resistor Z200 may be connected between the nodes T0C and T0A.

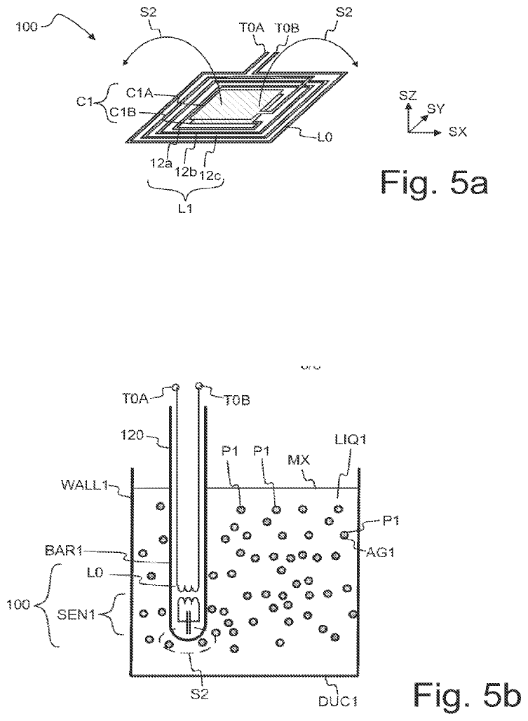

Referring to FIGS. 4a and 4b, the measuring device is configured to provide a spectral position fp of a resonance peak of the resonance circuit CIR1. A gain response function R(f) may also be provided, having a local minimum at the resonance frequency fp of the resonance circuit CIR1. The gain response function R(f) may be represented as a gain response curve. The measuring device 500 may be arranged to identify one or more features of the gain response R(f). For example, the measuring device 500 may be arranged to detect a resonance portion of the gain response curve. The measuring device 500 may be arranged to detect a resonance dip RDIP of the gain response curve R(f). The measuring device 500 may be arranged to determine one or more characteristic values from the features of the gain response curve R(f). For example, the measuring device 500 may be arranged to determine a resonance frequency fp by determining a frequency where the gain response R(f) has a local minimum. For example, the measuring device 500 may be arranged to determine a spectral width BWG by analysing the gain response curve R(f) in the vicinity of the resonance frequency fp.

FIG. 4a shows a gain response curve R(f) associated with a first composition of the fluid MX, and FIG. 4b shows a gain response curve R(f) associated with a second different composition of the fluid MX. FIG. 4a may be associated with a first state of the fluid MX, and FIG. 4b may be associated with a second state of the fluid MX. The gain response curves R(f) may be measured by using the set-up shown in FIG. 3b. The gain response R(f) may have a local minimum at the resonance frequency fp of the resonance circuit CIR1. The gain response curve R(f) may have a resonance dip RDIP at the resonance frequency fp of the resonance circuit CIR1. The gain response R(f) may have a minimum value RMIN and a maximum value RMAX. ΔR denotes the difference RMAX−RMIN, i.e. the depth of the resonance dip RDIP. The resonance dip RDIP may have a spectral width BWG, which may mean the difference between the frequencies where the gain response R(f) is reduced by 3 dB when compared with the maximum value RMAX.

A change of the composition of the fluid MX may cause a change of the resonance frequency fp and/or may cause a change of the spectral width BWG. The resonance frequency fp and/or the spectral width BWG may be determined by analyzing the driving signal S0. A change of the resonance frequency fp and/or a change of the spectral width BWG may be determined by analyzing the driving signal S0. A relation between a change of a measurand and a change of a characteristic feature of the gain response R(f) may be determined.

The fluid MX may have a first state at a first time (t1) and a second state at a second time (t2). For example, the concentration of particles P1 at a time t1 may be different from the concentration of particles P1 at a time t2. The measuring may comprise a first gain response when the fluid MX is in the first state, and measuring a second gain response when the fluid MX is in the second different state. The change of the concentration may be detected by comparing the second gain response with the first gain response. The change of a concentration of a substance in the fluid MX may alter the gain response, and the change of the concentration may be determined by measuring the change of the gain response when compared with the initial situation.

The measurements may comprise measuring a gain response R(f) as a function of frequency f, and determining a spectral position fp of a feature of the gain response R(f). The measurements may comprise measuring a gain response R(f) as a function of frequency f, and determining a spectral width BWG of a feature of the gain response R(f). The measurements may comprise measuring the impedance Z100(f) of the coupled reader coil L0 as a function of frequency f, and determining the resonance frequency fp and/or the spectral width BWG from the impedance Z100(f) of the coupled reader coil L0. The measurements may comprise measuring the impedance ZSEN(f) of the coupled sensor coil L1 as a function of frequency f, and determining the resonance frequency fp and/or the spectral width BWG from the impedance ZSEN(f) of the coupled sensor coil L1. The measurements may comprise determining at least one property X1, X2 from the measured spectral position fp and/or from the measured spectral width BWG.

A spectral feature of the impedance Z100 or ZSEN is in one embodiment described by fitting a polynomial function to the spectral feature. A characteristic portion of a gain response R(f) is in one embodiment described by fitting a polynomial function to the characteristic portion. The measurement may comprise performing polynomial fitting to a measured gain response curve R(f) so as to determine one or more numerical values associated with a characteristic portion of the gain response curve. The measured gain response curve may have a dip RDIP on the frequency axis. The dip RDIP may be characterized by two features: the resonance frequency fp and the bandwidth (BWG) of the dip. These features may be extracted by fitting a polynomial model on the measured gain response. The method may optionally comprise measuring a baseline gain response in a situation where the reader coil L0 is not coupled to the resonance circuit CIR1. The baseline of the decoupled reader coil may be optionally subtracted from the measured gain response R(f) in order to provide a compensated gain response. A polynomial function may be subsequently fitted to the measured gain response curve or to the compensated gain response curve. The polynomial function may be a 3rd order polynomial. The 3rd order polynomial may provide a relatively robust and generalized model to describe the peaks and dips of frequency response data. The 3rd order polynomial may also take into account possible asymmetry of the resonance dip RDIP. The resonance frequency fp may be determined to be a frequency where the fitted (polynomial) function attains its minimum value. The spectral width BWG may be determined by using the fitted (polynomial) function. The gain response R(f) may have a maximum value RMAX, and the resonance dip RDIP may have a depth ΔR. The spectral width BWG may be the spectral difference between the two points where the fitted polynomial function is equal to RMAX−ΔR/√2. The spectral width BWG may be the spectral difference which corresponds to −3 dB bandwidth. The resonance frequency fp may depend on the relative permittivity of the sample volume of the fluid MX. The spectral width BWG may depend on the losses in the resonator and the dielectric losses in the sample volume of the fluid MX.

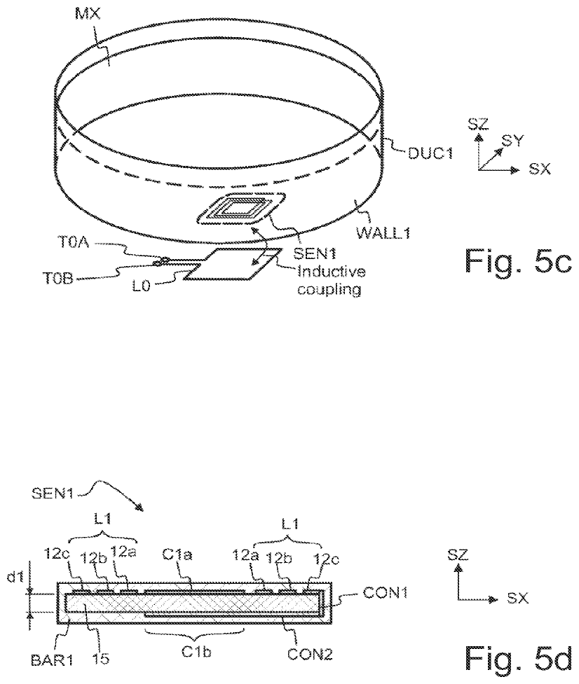

FIG. 5a illustrates one exemplary embodiment of the structure of the electrically conductive parts of the sensor unit 100. The sensor unit 100 comprises the resonance circuit CIR1. The resonance circuit CIR1 comprises the capacitor C1 and the inductor L1 connected in parallel. The capacitor C1 comprises capacitive elements C1a, C1b. At least one of the capacitive elements C1a, C1b may operate as the capacitive electrode of the sensor unit 100. At least one of the elements C1a, C1b may generate the oscillating electromagnetic field S2 during operation of the sensor unit 100. The elements C1a, C1b may be capacitive plates. The elements C1a, C1b may be planar plates. The elements C1a, C1b may together form a parallel plate capacitor C1. The inductor L1 comprises one or more turns 12a, 12b, 12c. Alternatively, or in addition, the sensor unit 100 comprises the reader coil L0. The reader coil L0 may have terminals T0a, T0B for coupling the driving signal S0 to the reader coil L0. The reader coil L0 may comprise one or more turns of a conductor. The coil L1 and the capacitive electrodes C1a, C1b may be implemented on a substrate, on a plastic foil. The coil L1 and the capacitive electrodes C1a, C1b may be formed from a metal foil by etching, by laser cutting. The coil L1 and the capacitive electrodes C1a, C1b may be formed by applying electrically conductive material on the substrate. The sensor module SEN1 or the sensor unit 100 may be encapsulated in an electrically insulating material, i.e. in a dielectric material. The sensor module SEN1 or the sensor unit 100 may be covered with a dielectric material. The sensor module SEN1 or the sensor unit 100 may be installed into an end of a probe. The sensor module SEN1 may be simple and robust. The sensor module SEN1 may suitable for use in an industrial environment. The sensor module SEN1 may be positioned close to a moving mixer blade. The sensor module SEN1 may be positioned close to a rotating impeller.

Referring to FIG. 5b, the sensor module SEN1 or the sensor unit 100 may be positioned in a measurement probe 120. The measurement probe 120 may be at least partly immersed in the fluid MX. An end of the measurement probe may be immersed in the fluid MX. The measurement probe may have a cylindrical form such that an end of the probe may be easily positioned inside a duct or container through an opening of a wall of the duct or container. The method may comprise using a measurement probe, which may comprise a resonance circuit, a sensor coil, a sensor antenna, a reader coil, and a dielectric barrier. The sensor coil may operate as an inductive part of the resonance circuit, and the sensor antenna may operate as a capacitive part of the resonance circuit. An oscillating voltage coupled to the reader coil may induce oscillating voltage in the resonance circuit so that the sensor antenna may generate an oscillating electromagnetic field in the heterogeneous mixture. The dielectric barrier may be positioned between the sensor antenna and the heterogeneous mixture in order to control and/or reduce losses caused by the heterogeneous mixture.

Referring to FIG. 5c, the sensor module SEN1 or the sensor unit 100 may be positioned on the inner surface of a container or duct DUC1. The reader coil L0 may be coupled to the sensor module SEN1 through a wall WALL1 of the container or duct DUC1. The sensor module SEN1 may be thin such that the sensor module SEN1 does not significantly disturb flow pattern inside the container or duct DUC1. The sensor module SEN1 may be attached to the inner surface of the wall WALL1 such that the sensor module SEN1 does not significantly protrude from the inner surface. The sensor module SEN1 may be thin such that the sensor module SEN1 does not significantly disturb operation of a mechanical stirring element. The electrically conductive parts L1, C1a, C1b of the sensor module SEN1 may be encapsulated in a dielectric material BAR1.

FIG. 5d, shows, by way of example, a cross-sectional view of the sensor module SEN1. The sensor module SEN1 may comprise a first capacitive element C1a and a second capacitive element C1b separated by a dielectric layer 15. The first capacitive element C1a may be connected to the inductor L1, which may comprise one or more turns 12a, 12b, 12c. The inductor L1 may be connected to the second capacitive element C1b by one or more conductive parts CON1, CON2. The conductive parts of the sensor module SEN1 may be encapsulated in the dielectric material BAR1. The elements C1a, C1b may be attached to the insulating layer 15 such that a change of pressure of the fluid MX does not cause a significant change of distance d1 between the elements C1a, C1b.

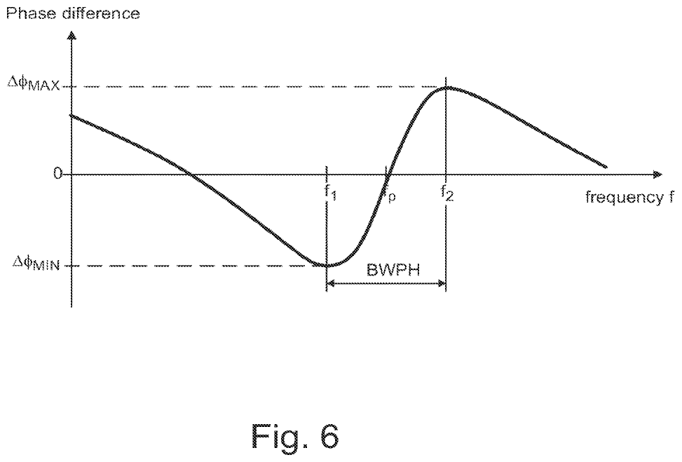

FIG. 6 illustrates one example of the phase difference ΔT between current i0(t) and voltage v0(t) waveforms of the reader coil L0. The phase difference ΔT may be substantially equal to zero at the resonance frequency fp. The phase difference Δφ may have a local minimum ΔφMIN at a frequency f1. The phase difference Δφ may have a local maximum ΔφMAX at a frequency f2. The difference f2−f1 may be called as the spectral width BWPH. The spectral width BWPH may denote the spectral separation f2−f1 between the frequencies f1, f2 associated with the minimum phase difference ΔφMIN and the maximum phase difference ΔφMAX. The method may comprise determining a spectral width BWPH from the measured phase shift φ(t). The method may comprise determining a property X1, X2 of the fluid MX from the spectral width BWPH. The method may comprise determining a property X1, X2 of the fluid MX from the resonance frequency fp and/or from the spectral width BWPH by using auxiliary parameters PARA1, such as calibration data.

The resonance frequency fp and/or the spectral width BWPH of a spectral feature may depend on a first property X1 of the fluid MX. For example, the first property X1 may have a value X1(t1) at a time t1 such that the value X1(t1) corresponds to a resonance frequency fp(t1) and a spectral width BWPH(t1). The first property X1 may be the mass fraction of particles P1 contained in the fluid MX. Consequently, the first property X1 may be determined from the resonance frequency fp and/or from the spectral width BWPH.

The sensor module SEN1 may be arranged to monitor a portion of the fluid MX which is located within a sample volume VOL1 in the vicinity of the sensor module SEN1. The sample volume VOL1 may have a position POS1, which may be specified by coordinates x,y,z. The sensor module SEN1 may be substantially insensitive to changes of particle concentration which take place outside the sample volume VOL1.

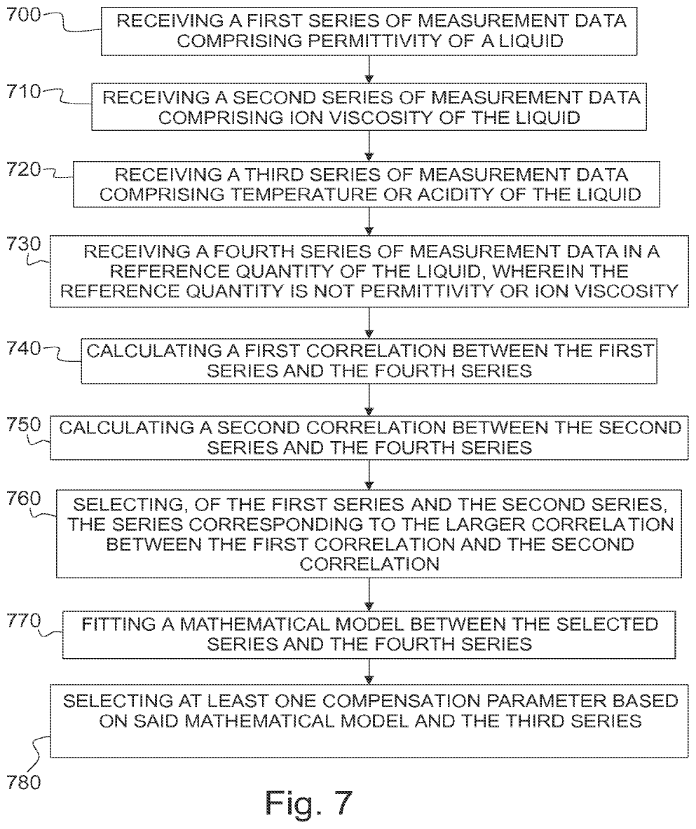

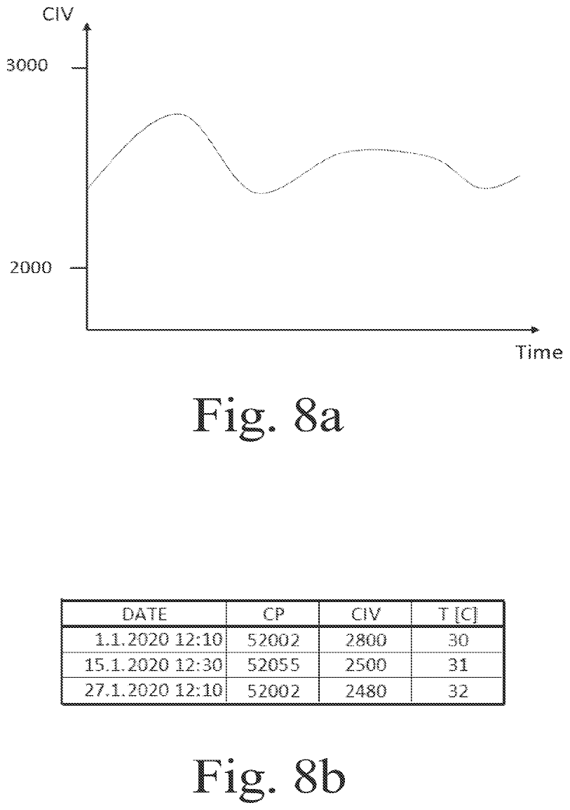

FIG. 7 illustrates a flowchart of one aspect of the method for calibrating the measuring device 500. FIG. 8a illustrates a chart of exemplary measurement data and FIG. 8b shows a table of data points with the same measurement data. In step 700 the measuring device 500 receives a first series of measurement data comprising permittivity CP of the fluid MX. In step 710 the measuring device 500 receives a second series of measurement data comprising ion viscosity CIV of the fluid MX. In step 720 the measuring device 500 receives a third series of measurement data comprising temperature T[C] of the fluid MX. In this exemplary embodiment, the first series, the second series and the third series are obtained by the sensor 100. In this embodiment the sensor 100 comprises a temperature sensor configured to measure temperature of the fluid MX and to provide the measurement data to the measuring device 500. Alternatively, the measuring device 500 receives the third series of measurement data comprising acidity pH of the fluid MX, from a sensor configured to measure acidity. The ion viscosity CIV and the permittivity CP are obtained by the arrangement described hereinbefore. In one embodiment the measuring device 500 is arranged at a distance from the sensor 100, wherein the communication between the sensor 100 and the measuring device 500 is executed via the transceiver 500.

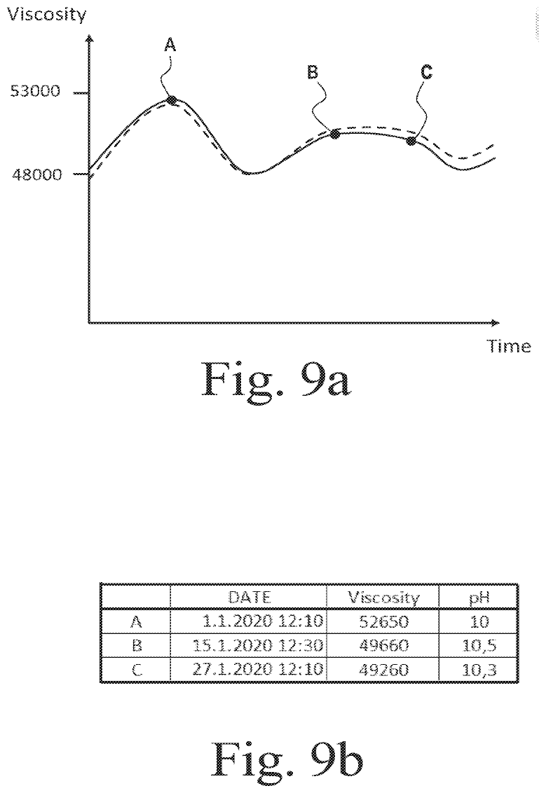

In step 730 the measuring device 500 receives a fourth series of measurement data in a reference quantity of the liquid, wherein the reference quantity is other than permittivity CP or ion viscosity CIV. FIG. 9a illustrates a chart of fourth series of measurement data, wherein the solid line illustrates the measured values of viscosity. The dashed line illustrates the ion viscosity as in FIG. 8a. FIG. 9b illustrates a table of the same values, wherein data points A, B and C are illustrated in the chart. The viscosity is in this example the reference quantity, not being either permittivity CP or ion viscosity CIV. The correlation between the viscosity and the ion viscosity CIV is high.

The fourth series of measurement data may be received from an external sensor, not part of the sensor 100. The fourth series of measurement data is in one embodiment received via the transceiver RXTX1, being in connection with an external system. For example, the external system providing the fourth series of measurement data may be a sensor from the industrial process.

The reference quantity is a quantity measurable from the fluid MX. The reference quantity is selected from the group of: acidity pH, viscosity, thixotropy, oil concentration, water content, fat content, solid content (dry mass), fluid composition, concentration of an element, metal particles, chemical concentration, concentration of multiple chemicals, conductivity, drying of polymer, drying of glue, drying of adhesive, polymerization, polymerization speed, polymerization dynamics, gelation of liquid, gelation speed, gelation dynamics, freezing of liquid, melting of liquid, gas bubbles in liquid, presence of gas in liquid, foam on liquid, foam density, liquid density, agglomeration, de-agglomeration, nanoparticles, crystallization, crystal growth, dissolving of a substance, particle size, biomass, bacteria growth, coagulation (e.g. milk), milk souring, recognizing liquids (fingerprinting), fermentation, oxidization of liquid, oxidation of wine, sedimentation, sedimentation speed and sedimentation dynamics. According to one definition, the reference quantity illustrates value of a variable quantity which relates to the conditions of the fluid MX and which is chosen as a measure.

The first series, the second series, the third series and the fourth series are in one embodiment data points occurring simultaneously. The first series and the second series are in one embodiment measured by the sensor 100 and obtained by the measuring device 500 simultaneously, as the first series is obtained as real portion of the impedance measurement and the second series is obtained as imaginary portion of the same impedance measurement. The temperature measurement may be obtained simultaneously from the sensor 100 as the impedance measurement. In one embodiment the temperature measurement is interpolated to the same time period as the impedance measurement.

In step 740 is calculated a first correlation between the first series and the fourth series. In step 750 is calculated a second correlation between the second series and the fourth series. The first correlation and the second correlation are in one embodiment calculated as correlation coefficients. The correlation coefficient is a numerical measure of correlation, defining a statistical relationship between two variables, or data points between two series. The correlation coefficient assumes values in the range from −1 to +1, where ±1 indicates the strongest possible agreement and 0 the strongest possible disagreement.

Step 760 comprises selecting, of the first series and the second series, the series corresponding to the higher correlation between the first correlation and the second correlation. In other words, the one series having stronger agreement with the series obtained from the reference quantity is selected to be applied in consequent steps.

In step 770 a mathematical model is fitted between the selected series and the fourth series, the series having higher correlation with the reference quantity. One embodiment of fitting the mathematical model is curve fitting, constructing a mathematical function, that has the best fit to the series of data points. In one embodiment the curve fitting involves interpolation, where an exact fit to the series of data points is required. In one embodiment the curve fitting involves smoothing, in which a function is constructed that approximately fits the series of data points. In one embodiment the mathematical model is a linear function, wherein a linear approximation on the differences between the selected series and the fourth series is applied. In one embodiment the mathematical model is a polynomial function. In one embodiment the mathematical model is created by partial-least squares regression. In one embodiment the mathematical model is created by principal component regression.

Step 780 comprises selecting at least one temperature compensation parameter based on said mathematical model and the third series. In one embodiment the temperature compensation parameter is a temperature coefficient. The temperature coefficient may be derived from said linear function.

In one exemplary embodiment the measurement device is calibrated repeatedly as the industrial process provides additional data for the fourth series of measurement data. The data is annotated, for example by a time stamp, and the calibration is further improved as the data series improves; causing to improve the mathematical model and the temperature compensation parameter. The measurement data may be calibrated in a cloud computing environment, where any of the first series, second series, third series or the fourth series of measurement data is stores. The arrangement enables adding various sensors to the measurement system or to detect various internal or external disturbances in the industrial process. The measurement data may be stored into a portable memory device and the data may be later collected and calibrated, compensated or adjusted according to annotated data received

In FIG. 9b illustrates an exemplary table with additional separate measurement, acidity pH. In some examples the industrial process has additional disturbances that may have a relation to the additional separate measurement, as the acidity in this example. The remaining measurements of either permittivity or ion viscosity, not used for temperature compensation, are in one embodiment used for compensating the other disturbances. One example of such disturbance is the variation of acidity in the fluid MX.

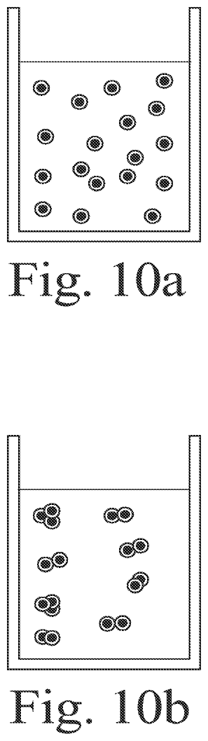

In one embodiment the fluid MX is a colloid. In one embodiment the fluid MX is colloidal suspension. In one embodiment the fluid MX comprises colloidal particles. The colloids have electrical characteristics, which are discussed next from the perspective of the suspensions. In some cases, the colloidal particles bond together to form agglomerates or dense coagulates. Sometimes they disperse into homogeneous, metastable mixtures. Both situations are illustrated, in FIG. 10a as an evenly dispersed colloid and in FIG. 10b as an agglomerated suspension which has partly sedimented due to agglomeration.

The behavior may be explained by the small size of the particles, which is why the interactive forces between them and the liquid phase are relatively more significant than the effect of gravity. These interactive forces exist even in large particles, but since the forces arise from the phenomena occurring at the interfaces, it is only in the colloidal size class that the surface area to weight ratio of the particle is large enough for the phenomena to occur.

One electrical force is a van der Waals attraction due to the polarization of molecules, another electrical force arises from the charge of the interface between the phases. The stability of colloidal particles is determined by the mutual magnitude of the forces; without the electrical charge of the particles, they would stick to each other. However, this is not always the case as inorganic particle surfaces often adsorb ions charged from solution, which in turn affect how gently the particles attract or repel each other. Sometimes light agglomeration is a desired property—for example, a rapid paint mixing can break the agglomerates and thus momentarily reduce the viscosity of the paint to facilitate application. More permanent ways of influencing interparticle interactions than mixing are altering the acidity and ionic balance of the suspension or using dispersants.

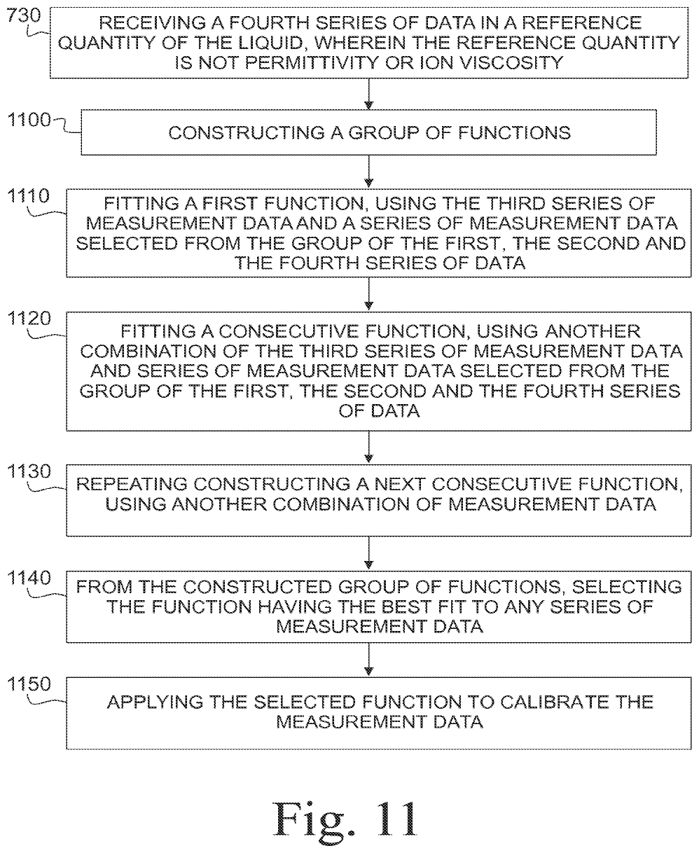

FIG. 11 illustrates a flowchart of one aspect of the method for calibrating the measuring device. Preceding steps 700, 710, 720 are similar to the method illustrated in FIG. 7. The flowchart start with step 730, receiving a fourth series of measurement data in a selected quantity of the liquid MX. The measured complex impedance provides information to extract various measurement data from the liquid MX. In one embodiment, the selected quantity is selected from the group of: acidity, viscosity, thixotropy, oil concentration, water content, fat content, solid content, dry mass, fluid composition, concentration of an element, metal particles, chemical concentration, concentration of multiple chemicals, conductivity, drying of polymer, drying of glue, drying of adhesive, polymerization, polymerization speed, polymerization dynamics, gelation of liquid, gelation speed, gelation dynamics, freezing of liquid, melting of liquid, gas bubbles in liquid, presence of gas in liquid, foam on liquid, foam density, liquid density, agglomeration, de-agglomeration, nanoparticles, crystallization, crystal growth, dissolving of a substance, particle size, biomass, bacteria growth, coagulation, milk souring, recognizing liquids by fingerprinting, fermentation, oxidization of liquid, oxidation of wine, sedimentation, sedimentation speed and sedimentation dynamics.

Step 1100 comprises constructing a group of functions that are continuous estimates to the series of measurement data. One example of such function is a curve fitting function. Curve fitting constructs a curve, or a function, that has the best fit to a series of measured data points. The curve fitting function may relate to interpolation, smoothing or extrapolation.

Each function is constructed by a repeating sequence. In step 1110 a first function is fitted, using the third series of measurement data as a starting point, i.e. the temperature measurement. Temperature variations have been shown to be dominant cause for measurement error. Additionally, a series of measurement data is selected from the group of the first series of measurement data, the second series of measurement data and the fourth series of measurement data. In other words, the first fitting function utilizes temperature measurement and any other measurement. In one embodiment, the fourth series of measurement data is obtained by the measuring device 500. In one embodiment, the fourth series of measurement data, or any other series of measurement data may be obtained from an external source, for example from an external sensor or additional measuring device.

Step 1120 comprises fitting a consecutive function, using another combination of the third series of measurement data and series of measurement data selected from the group of the first series of measurement data, the second series of measurement data and the fourth series of measurement data. Here the process searches for common dependencies between different measured series of data.

Step 1130 comprises repeating constructing a next consecutive function, using another combination of series of measurement data. In step 1140, from the constructed group of functions, is selected the function having the best fit to any series of measurement data. In step 1150 the selected function is applied to calibrate the measurement data. By having a fitted function for providing compensation or calibration to the measurement results, the measuring device's 500 calibration range is extended. The calibration method may be iteratively used to improve the measurements.

The calibration method may be iterative or recurring. In one embodiment, the method further comprises receiving a fifth series of measurement data in a selected quantity of the liquid MX; and using the fifth series of data to construct the next consecutive function for the group of functions. In one embodiment, the method further comprises receiving a sixth series of measurement data in a second selected quantity of the liquid MX; and using the sixth series of data to construct the next consecutive function for the group of functions.

The method may search for all possible combinations or restrict the search and fitting for predefined number of combinations. The inventors have discovered that the number of selected quantities or combinations thereof are not related to improved results. Different measured quantities CP, CV, Z1, Z2, Z3, T1, T2, T3, . . . may be available. The technical problem lies in finding a solution for the equation:

Y=F(CP,CIV . . . ,ET) as temperature causes interference to the measurement.

The process may start with as few variables, i.e. series of measurement results as possible. Models for converting measured quantity and measured temperature to target value Y. The predicted values of each model to are compared to reference values and key figures are calculated for validating the function. One quantity at a time is added to the method for finding the fitting calibration function. The selected quantity may be externally provided quantity, such as acidity or quantity derived from the measuring device 500 measurements. Key figures are calculated and compared to previous results, if the fitting results are improved, the process may continue with additional quantities. If the fitting results do not improve, the process may be stopped and the best fitting function is further used for calibration.

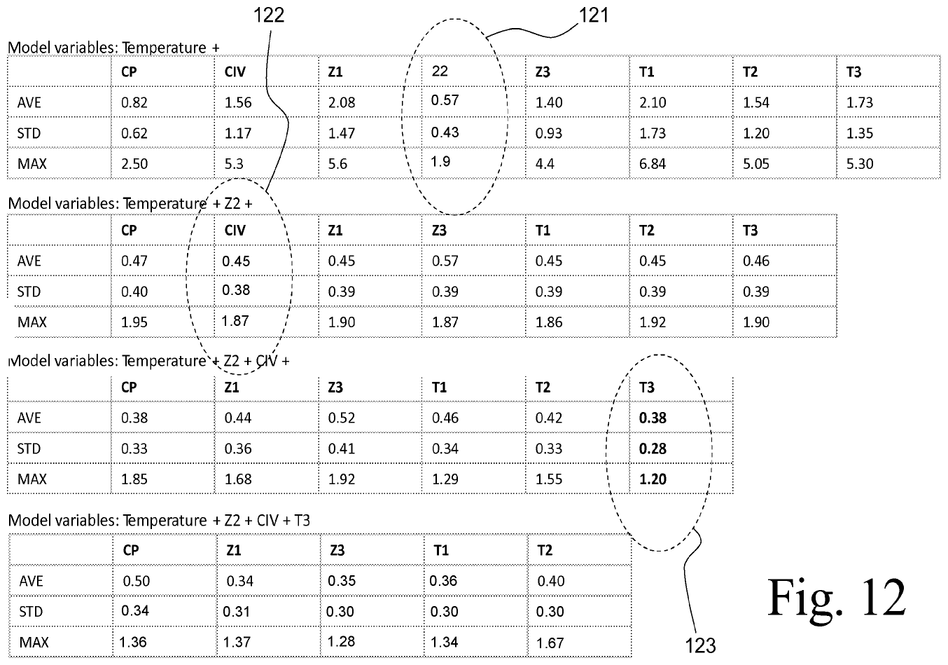

FIG. 12 illustrates one example of four different combinations, where various quantities have been utilized in fitting the function against the measurements. The first function fitting utilizes only temperature, where quantity Z2 is found to be having the best fit according to the table of FIG. 12, highlighted by 121. In this example, the compared parameters are average prediction error, standard prediction error and maximum prediction error. In one embodiment, the function having the best fit is selected according to a smallest maximum prediction error to any series of measurement data. In one embodiment, the function having the best fit is selected according to the smallest average prediction error to any series of measurement data.

In the next step, the second function fitting utilizes temperature and quantity Z2, wherein CIV is found to be having the best fit, highlighted by 122. The third step uses the combination of temperature, Z2 and CIV, wherein the quantity T3 has the best fit, highlighted by 123.

The following step uses four quantities: temperature, Z2, CIV, and T3. In this example is discovered that using four quantities provides worse fitting than using three quantities. Therefore, the function being used for temperature, Z2 and CIV is selected for calibration and/or measurement compensation.

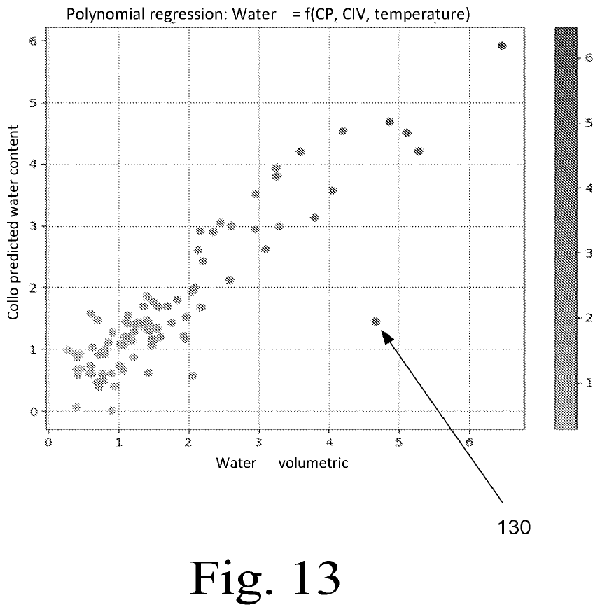

The function for fitting is selected from a group of: Polynomial Regression, SVR, Random Forest Regression, A priori, Decision Tree Classification, Decision Tree Regression, Hierarchical clustering, K Nearest Neighbors, Kernel SVM, Logistic Regression, Multiple Linear Regression, Naive Bayes, Neural Network MLP Regressor, Random forest Classification, Simple Linear Regression and SVM. The method may utilize all available functions by the steps described hereinbefore or select a predefined set of functions. Some functions may provide surprising errors. FIG. 13 illustrates one example of a polynomial regression plot with single outlier result 130 to an otherwise well-fitting prediction function.

In one embodiment, the neural network is used for detecting the measurement. The neural network is taught by dividing the measurement data into two portions. A first portion of the measurement data is applied to teaching a machine learning algorithm as the function for fitting. The second portion of the measurement data is applied to validating the machine learning algorithm.

A method for calibrating a measuring device is disclosed herein, comprising: receiving a first series of measurement data comprising permittivity of a liquid; receiving a second series of measurement data comprising ion viscosity of the liquid; receiving a third series of measurement data comprising temperature of the liquid; and receiving a fourth series of measurement data in a selected quantity of the liquid; constructing a group of functions, wherein each function is constructed by: fitting a first function, using the third series of measurement data and a series of measurement data selected from the group of the first series of measurement data, the second series of measurement data and the fourth series of measurement data; fitting a consecutive function, using another combination of the third series of measurement data and series of measurement data selected from the group of the first series of measurement data, the second series of measurement data and the fourth series of measurement data; and repeating constructing a next consecutive function, using another combination of series of measurement data; from the constructed group of functions, selecting the function having the best fit to any series of measurement data; and applying the selected function to calibrate the measurement data. In one embodiment, the method further comprises receiving a fifth series of measurement data in a selected quantity of the liquid (MX); and using the fifth series of data to construct the next consecutive function for the group of functions. In one embodiment, the method further comprises receiving a sixth series of measurement data in a second selected quantity of the liquid (MX); and using the sixth series of data to construct the next consecutive function for the group of functions. In one embodiment, the method comprises selecting the function having the best fit according to a smallest maximum prediction error to any series of measurement data. In one embodiment, the method comprises selecting function having the best fit according to the smallest average prediction error to any series of measurement data. In one embodiment, the method comprises applying a first portion of the measurement data for teaching a machine learning algorithm as the function for fitting and applying a second portion of the measurement data for validating the machine learning algorithm. In one embodiment, the function for fitting is selected from a group of: Polynomial Regression, SVR, Random Forest Regression, A priori, Decision Tree Classification, Decision Tree Regression, Hierarchical clustering, K Nearest Neighbors, Kernel SVM, Logistic Regression, Multiple Linear Regression, Naive Bayes, Neural Network MLP Regressor, Random forest Classification, Simple Linear Regression and SVM. In one embodiment, the method comprises receiving a fourth series of measurement data in a selected quantity of the liquid, wherein the selected quantity is other than the first series of the measurement data or the second series of the measurement data; calculating a first correlation between the first series and the fourth series; calculating a second correlation between the second series and the fourth series; selecting, of the first series and the second series, the series corresponding to the higher correlation between the first correlation and the second correlation; fitting a mathematical model between the selected series and the fourth series; selecting at least one compensation parameter based on said mathematical model and the third series; and compensating, by the at least one compensation parameter, the series of measurement data corresponding to the higher correlation between the first correlation and the second correlation. In one embodiment, the method comprises selecting, of the first series and the second series, the series corresponding to the lower correlation between the first correlation and the second correlation; and applying it to compensating additional measurement in additional quantity. In one embodiment, the compensation parameter is a temperature coefficient. In one embodiment, the mathematical model is a linear function or a polynomial function. In one embodiment, the liquid comprises colloidal particles. In one embodiment, the selected quantity is selected from the group of: acidity, viscosity, thixotropy, oil concentration, water content, fat content, solid content, dry mass, fluid composition, concentration of an element, metal particles, chemical concentration, concentration of multiple chemicals, conductivity, drying of polymer, drying of glue, drying of adhesive, polymerization, polymerization speed, polymerization dynamics, gelation of liquid, gelation speed, gelation dynamics, freezing of liquid, melting of liquid, gas bubbles in liquid, presence of gas in liquid, foam on liquid, foam density, liquid density, agglomeration, de-agglomeration, nanoparticles, crystallization, crystal growth, dissolving of a substance, particle size, biomass, bacteria growth, coagulation, milk souring, recognizing liquids by fingerprinting, fermentation, oxidization of liquid, oxidation of wine, sedimentation, sedimentation speed and sedimentation dynamics.

Alternatively, or in addition, a measuring device is disclosed. The measuring device comprises a transceiver; at least one processor and a memory storing instructions that, when executed, cause the device to: receive a first series of measurement data comprising permittivity of a liquid; receive a second series of measurement data comprising ion viscosity of the liquid; receive a third series of measurement data comprising temperature of the liquid; and receive a fourth series of measurement data in a selected quantity of the liquid; construct a group of functions, wherein each function is constructed by: fit a first function, using the third series of measurement data and a series of measurement data selected from the group of first series of measurement data, the second series of measurement data and the fourth series of measurement data; fit a consecutive function, using another combination of the third series of measurement data and series of measurement data selected from the group of first series of measurement data, the second series of measurement data and the fourth series of measurement data; and repeat constructing a next consecutive function, using another combination of series of measurement data; from the constructed group of functions, select the function having the best fit to any series of measurement data; and apply the selected function to calibrate the measurement data. In one embodiment, the at least one processor and a memory storing instructions that, when executed, cause the device to receive fifth series of measurement data in a selected quantity of the liquid; and to use the fifth series of data to construct the next consecutive function for the group of functions. In one embodiment, the at least one processor and a memory storing instructions that, when executed, cause the device to receive a sixth series of measurement data in a second selected quantity of the liquid; and to use the sixth series of data to construct the next consecutive function for the group of functions. In one embodiment, the at least one processor and a memory storing instructions that, when executed, cause the device to select the function having the best fit according to a smallest maximum prediction error to any series of measurement data. In one embodiment, the at least one processor and a memory storing instructions that, when executed, cause the device to select the function having the best fit according to the smallest average prediction error to any series of measurement data. In one embodiment, the at least one processor and a memory storing instructions that, when executed, cause the device to apply a first portion of the measurement data for teaching a machine learning algorithm as the function for fitting and to apply a second portion of the measurement data for validating the machine learning algorithm. In one embodiment, the device is configured to measure the liquid that comprises colloidal particles.

Alternatively, or in addition a method for calibrating a measuring device is disclosed herein. The method comprises receiving a first series of measurement data comprising permittivity of a liquid; receiving a second series of measurement data comprising ion viscosity of the liquid; receiving a third series of measurement data comprising temperature or acidity of the liquid; receiving a fourth series of measurement data in a reference quantity of the liquid, wherein the reference quantity is other than the first series of the measurement data or the second series of the measurement data; calculating a first correlation between the first series and the fourth series; calculating a second correlation between the second series and the fourth series; selecting, of the first series and the second series, the series corresponding to the higher correlation between the first correlation and the second correlation; fitting a mathematical model between the selected series and the fourth series; and selecting at least one temperature compensation parameter based on said mathematical model and the third series. In one embodiment, the compensation parameter is a temperature coefficient. In one embodiment, the mathematical model is a linear function. In one embodiment, the mathematical model is a polynomial function. In one embodiment, the liquid comprises colloidal particles. In one embodiment, the method comprises selecting, of the first series and the second series, the series corresponding to the lower correlation between the first correlation and the second correlation; and applying it to compensating additional measurement in additional quantity.

Alternatively, or in addition a device is disclosed herein. The device comprises a transceiver; at least one processor and a memory storing instructions that, when executed, cause the device to: receive a first series of measurement data comprising permittivity of a liquid; receive a second series of measurement data comprising ion viscosity of the liquid; receive a third series of measurement data comprising temperature of the liquid; receive a fourth series of measurement data in a reference quantity of the liquid, wherein the reference quantity is not permittivity or ion viscosity; calculate a first correlation between the first series and the fourth series; calculate a second correlation between the second series and the fourth series; select, of the first series and the second series, the series corresponding to the higher correlation between the first correlation and the second correlation; fit a mathematical model between the selected series and the fourth series; and select at least one temperature compensation parameter based on said mathematical model and the third series. In one embodiment, the compensation parameter is a temperature coefficient. In one embodiment, the mathematical model is a linear function. In one embodiment, the mathematical model is a polynomial function. In one embodiment, the liquid comprises colloidal particles. In one embodiment, the at least one processor and a memory storing instructions that, when executed, cause the device to select, of the first series and the second series, the series corresponding to the lower correlation between the first correlation and the second correlation; and apply it to compensating additional measurement in additional quantity.

Alternatively, or in addition, the functionality described herein can be performed, at least in part, by one or more hardware components or hardware logic components.

An example of the measuring device described hereinbefore is a computing-based device comprising one or more processors which may be microprocessors, controllers or any other suitable type of processors for processing computer-executable instructions to control the operation of the device in order to control one or more sensors, receive sensor data and use the sensor data. The computer-executable instructions may be provided using any computer-readable media that is accessible by a computing-based device. One example of the computing-based device is arranged in a cloud computing environment. Computer-readable media may include, for example, computer storage media such as memory and communications media. Computer storage media, such as memory, includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other memory technology, CD-ROM, digital versatile disks (DVD) or other optical storage, SSD drives, magnetic cassettes, magnetic tape, magnetic disk storage or other magnetic storage devices or any other non-transmission medium that can be used to store information for access by a computing device. In contrast, communication media may embody computer-readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media is shown within the computing-based device, it will be appreciated that the storage may be distributed or located remotely and accessed via a network or other communication link, for example, by using a communication interface.

The apparatus or the device may comprise an input/output controller arranged to output display information to a display device which may be separate from or integral to the apparatus or device. The input/output controller is also arranged to receive and process input from one or more devices, such as a user input device (a mouse, keyboard, camera, microphone or other sensor).

The methods described herein may be performed by a software in machine-readable form on a tangible storage medium in the form of a computer program comprising computer program code means adapted to perform all the steps of any of the methods described herein when the program is run on a computer and where the computer program may be embodied on a computer-readable medium. Examples of tangible storage media include computer storage devices comprising computer-readable media, such as disks, thumb drives, memory etc. and do not only include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

Any range or device value given herein may be extended or altered without losing the effect sought.

Although at least a portion of the subject matter has been described in language specific to structural features and/or acts, it is to be understood that the subject matter defined in the accompanying claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or device may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method for calibrating a measuring device, comprising:
receiving a first series of measurement data comprising permittivity of a liquid;
receiving a second series of measurement data comprising ion viscosity of the liquid;
receiving a third series of measurement data comprising temperature of the liquid;
receiving a fourth series of measurement data in a selected quantity of the liquid;
constructing a group of functions, wherein each function is constructed by:
fitting a first function, using the third series of measurement data and a series of measurement data selected from the group of the first series of measurement data, the second series of measurement data and the fourth series of measurement data;
fitting a consecutive function, using another combination of the third series of measurement data and series of measurement data selected from the group of the first series of measurement data, the second series of measurement data and the fourth series of measurement data; and
repeating constructing a next consecutive function, using another combination of series of measurement data;
from the constructed group of functions, selecting the function having the best fit to any series of measurement data; and
applying the selected function to calibrate the measurement data.

2. The method according to claim 1, further comprising:
receiving a fifth series of measurement data in a selected quantity of the liquid; and
using the fifth series of data to construct the next consecutive function for the group of functions.

3. The method according to claim 1, further comprising:
receiving a sixth series of measurement data in a second selected quantity of the liquid; and
using the sixth series of data to construct the next consecutive function for the group of functions.

4. The method according to claim 1, wherein selecting the function having the best fit to any series of measurement data comprises selecting the function having the best fit according to a smallest maximum prediction error to any series of measurement data.

5. The method according to claim 1, wherein selecting the function having the best fit to any series of measurement data comprises selecting the function having the best fit according to the smallest average prediction error to any series of measurement data.

6. The method according to claim 1, further comprising:
applying a first portion of the measurement data for teaching a machine learning algorithm as the function for fitting; and
applying a second portion of the measurement data for validating the machine learning algorithm.

7. The method according to claim 1, wherein:
the selected quantity is other than the first series of the measurement data or the second series of the measurement data; and
the method further comprises:
calculating a first correlation between the first series and the fourth series;
calculating a second correlation between the second series and the fourth series;
selecting, of the first series and the second series, the series corresponding to the higher correlation between the first correlation and the second correlation;
fitting a mathematical model between the selected series and the fourth series;
selecting at least one compensation parameter based on said mathematical model and the third series; and
compensating, by the at least one compensation parameter, the series of measurement data corresponding to the higher correlation between the first correlation and the second correlation.

8. The method according to claim 7, wherein selecting the series corresponding to the higher correlation comprises:
selecting, of the first series and the second series, the series corresponding to the lower correlation between the first correlation and the second correlation; and
applying the selected series to compensating additional measurement in additional quantity.

9. The method according to claim 7, wherein the compensation parameter is a temperature coefficient.

10. The method according to claim 1, wherein the liquid comprises colloidal particles.

11. A measuring device, comprising:
a transceiver;
at least one processor and a memory storing instructions that, when executed, cause the device to:
receive a first series of measurement data comprising permittivity of a liquid;
receive a second series of measurement data comprising ion viscosity of the liquid;
receive a third series of measurement data comprising temperature of the liquid;
receive a fourth series of measurement data in a selected quantity of the liquid;
construct a group of functions, wherein each function is constructed by:
fit a first function, using the third series of measurement data and a series of measurement data selected from the group of first series of measurement data, the second series of measurement data and the fourth series of measurement data;
fit a consecutive function, using another combination of the third series of measurement data and series of measurement data selected from the group of first series of measurement data, the second series of measurement data and the fourth series of measurement data; and
repeat constructing a next consecutive function, using another combination of series of measurement data;
from the constructed group of functions, select the function having the best fit to any series of measurement data; and
apply the selected function to calibrate the measurement data.

12. The measuring device according to claim 11, wherein the instructions that, when executed, further cause the device to:
receive fifth series of measurement data in a selected quantity of the liquid; and
use the fifth series of data to construct the next consecutive function for the group of functions.

13. The measuring device according to claim 11, wherein the instructions that, when executed, further cause the device to:
receive a sixth series of measurement data in a second selected quantity of the liquid; and
use the sixth series of data to construct the next consecutive function for the group of functions.

14. The measuring device according to claim 11, wherein, when the device is caused to select the function having the best fit to any series of measurement data, the device is caused to select the function having the best fit according to a smallest maximum prediction error to any series of measurement data.

15. The measuring device according to claim 11, wherein, when the device is caused to select the function having the best fit to any series of measurement data, the device is caused to select the function having the best fit according to the smallest average prediction error to any series of measurement data.

16. The measuring device according to claim 11, wherein the instructions, when executed, further cause the device to:
apply a first portion of the measurement data for teaching a machine learning algorithm as the function for fitting; and
apply a second portion of the measurement data for validating the machine learning algorithm.

17. The measuring device according to claim 11, wherein:
the selected quantity is other than the first series of the measurement data or the second series of the measurement data; and
the instructions, when executed, further cause the device to:
calculate a first correlation between the first series and the fourth series;
calculate a second correlation between the second series and the fourth series;
select, of the first series and the second series, the series corresponding to the higher correlation between the first correlation and the second correlation;
fit a mathematical model between the selected series and the fourth series;
select at least one compensation parameter based on said mathematical model and the third series; and
compensate, by the at least one compensation parameter, the series of measurement data corresponding to the higher correlation between the first correlation and the second correlation.

18. The measuring device according to claim 17, wherein, when the device is caused to select the series corresponding to the higher correlation, the device is caused to:
select, of the first series and the second series, the series corresponding to the lower correlation between the first correlation and the second correlation; and
apply the selected series to compensating additional measurement in additional quantity.

19. The measuring device according to claim 17, wherein the compensation parameter is a temperature coefficient.

20. The measuring device according to claim 11, wherein the device is configured to measure the liquid that comprises colloidal particles.
